(19) United States
(12) Patent Application Publication
(10) Pub. No.: US 2026/0339385 A1
(43) Pub. Date: Oct. 29, 2026

(54) Computer Case with a Curved Surface Display

(71) Applicant: Shanghai TRYX Technology Co., Ltd., Shanghai (CN)

(72) Inventors: CHIH-HSUAN LIN, Shanghai (CN); Chi LIU, Shanghai (CN); Xingzhe WANG, Shanghai (CN); Zepeng WANG, Shanghai (CN); Weiyi CHEN, Shanghai (CN)

(21) Appl. No.: 19/435,336

(22) Filed: Dec. 29, 2025

(30) Foreign Application Priority Data
Apr. 28, 2025 (CN) 202520825226.9

(51) Int. Cl. G06F 1/16; G06F 1/18

(52) U.S. Cl. CPC G06F 1/1601; G06F 1/181

(57) ABSTRACT

The invention provides a computer case with a curved surface display. The computer case comprises a case shell. A detachable curved display module is mounted on the outer surface of the case shell. The curved display module comprises a first display portion and a second display portion connected to the first display portion. The first display portion and the second display portion are non-coplanar to form a curved display effect. By providing the detachable curved display module on the case shell, which can be cancelled and replaced, a naked-eye 3D special effect can be achieved on the computer case. It is very suitable for providing users with functions such as viewing other display pictures or message prompts while using the computer for activities such as gaming.

### CROSS REFERENCE OF RELATED APPLICATIONS

The present application claims the priority of the Chinese utility model patent application which application number is 202520825226.9 filed Apr. 28, 2025, and the contents of which are hereby incorporated into this application by reference.

### FIELD OF THE INVENTION

The invention belongs to the technical field of computer cases, and specifically relates to a computer case with a curved surface display.

### BACKGROUND

A computer case is an important component of a computer. Currently, related products of computer cases mainly focus on more conveniently placing and fixing various components inside the computer case, better achieving the heat dissipation performance of the computer case, etc., with less involvement in improvements to the outer surface of the computer case.

Therefore, to improve the user experience and enrich the functional use of the computer case, it is necessary to provide a computer case with a display function on its outer side, particularly a computer case with a curved surface display function, to achieve a naked-eye 3D special effect on the computer case, which is very suitable for providing users with functions such as viewing other display pictures or message prompts while using the computer for activities such as gaming.

### SUMMARY OF INVENTION

Aiming at the deficiencies of the prior art, the invention provides a computer case with a curved surface display.

To solve the above technical problem, the invention provides a computer case with a curved surface display. Its main feature is that the computer case comprises a case shell, a detachable curved display module is mounted on an outer surface of the case shell, the curved display module comprises a first display portion and a second display portion connected to the first display portion, and the first display portion and the second display portion are non-coplanar to form a curved display effect.

Preferably, the case shell has a notch, the curved display module is installed in the notch, the notch comprises a first area and a second area, the first area and the second area are non-coplanar, the first display portion is mounted in the first area, and the second display portion is mounted in the second area.

Preferably, the computer case has a front panel, a rear panel, a left side panel and a right side panel, the first area of the notch is located on the front panel, the second area of the notch is located on the left side panel and/or the right side panel, the curved display module comprises a curved portion connecting the first display portion and the second display portion, and the curved portion is located at a junction of the front panel and the left side panel and/or located at a junction of the front panel and the right side panel.

Preferably, an inner side of the curved display module is connected by a magnetic snap-fit assembly.

Preferably, the magnetic snap-fit assembly comprises a first engaging member and a second engaging member, the first engaging member comprises a first magnetic portion and engaging pins arranged circumferentially around the first magnetic portion, the second engaging member comprises a second magnetic portion and engaging slots arranged circumferentially around the second magnetic portion, the first magnetic portion matches with the second magnetic portion to generate a magnetic attraction force, and the engaging pins match with the engaging slots.

Preferably, an outer fixing seat is provided on an outer side of the curved display module, the outer fixing seat has a display window matching the curved display module, the outer fixing seat is used for mounting the curved display module on the case shell, and the curved display screen of the curved display module is displayed through the display window.

Preferably, the computer case is configured with a replaceable mounting block, an outer contour of the replaceable mounting block matches an outer contour of the notch, and the replaceable mounting block is used to replace the curved display module and be installed in the notch.

Preferably, the curved display module is electrically connected to a mainboard inside the computer case.

The computer case with a curved surface display of the invention is provided with the detachable curved display module on the case shell, which can be cancelled and replaced. It can achieve a naked-eye 3D special effect on the computer case, and is very suitable for providing users with functions such as viewing other display pictures or message prompts while using the computer for activities such as gaming.

### BRIEF DESCRIPTION OF THE DRAWINGS

FIG. 1 and FIG. 2 are partial exploded views of the computer case with a curved surface display according to the invention from different perspectives, respectively.

FIG. 3 is an enlarged schematic diagram of the curved display module in FIG. 2.

FIG. 4 is a structural schematic diagram of the computer case with a curved surface display according to the invention when the outer fixing seat is removed.

FIG. 5 is a structural schematic diagram of the computer case with a curved surface display according to the invention after assembly.

### DETAILED DESCRIPTION

To make the technical problem solved by the invention clearer, the following further describes the invention with reference to the embodiments and drawings. The specific embodiments described herein are intended to explain the invention only and are not intended to limit the invention.

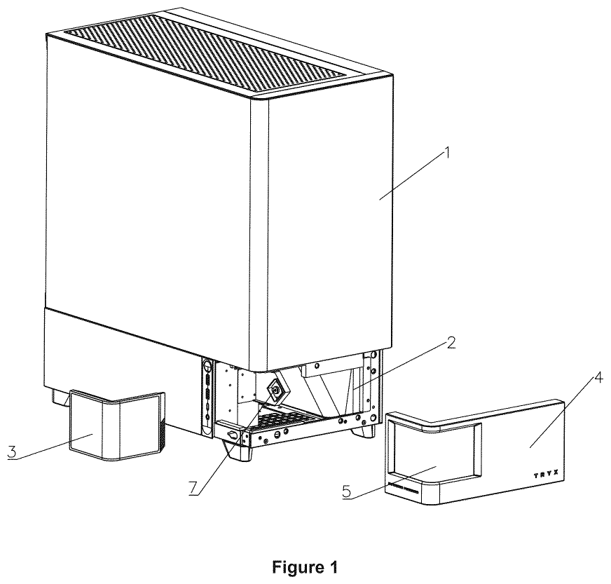

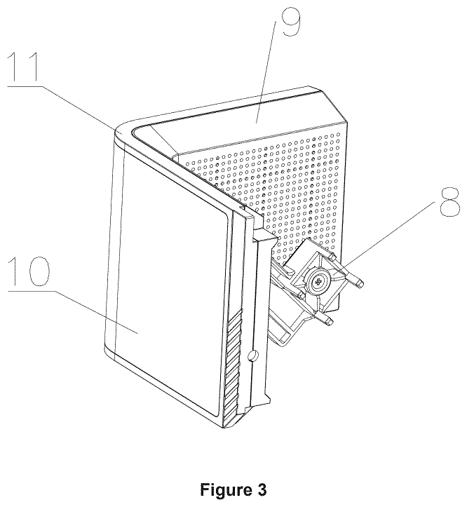

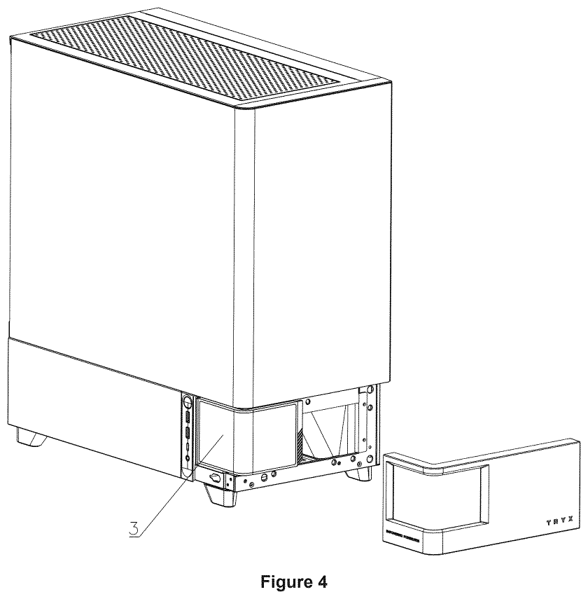

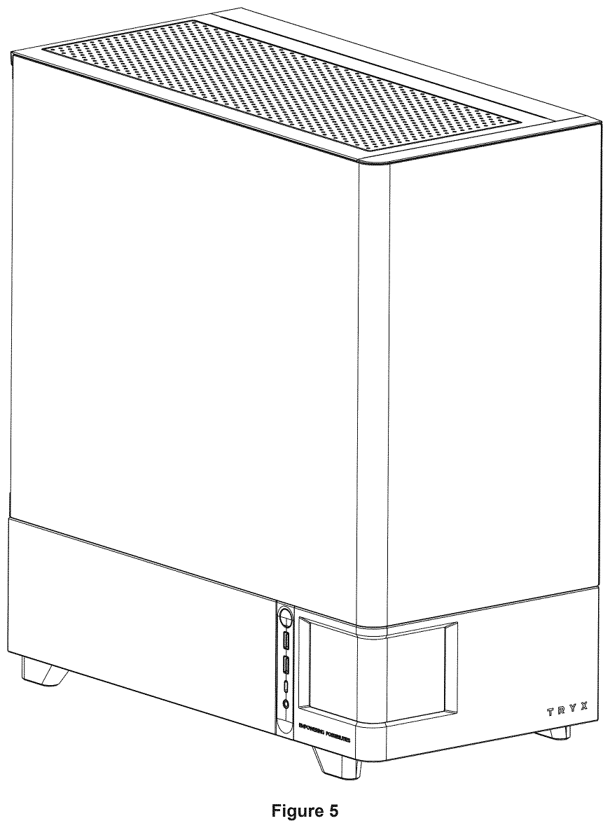

As shown in FIG. 1 to FIG. 5, an embodiment of a computer case with a curved surface display according to the present invention is illustrated. The computer case comprises a case shell 1, and a detachable curved display module 3 is mounted on the outer surface of the case shell 1. As shown in FIG. 3, the curved display module 3 comprises a first display portion 9 and a second display portion 10 connected to the first display portion 9. The first display portion 9 and the second display portion 10 are non-coplanar to form a curved display effect. The curved display module 3 is electrically connected to a mainboard inside the computer case. The curved display module 3 has a curved display screen, which serves as a secondary screen of the computer to display desired content. The case shell can be made of materials such as glass, plastic, metal, etc.

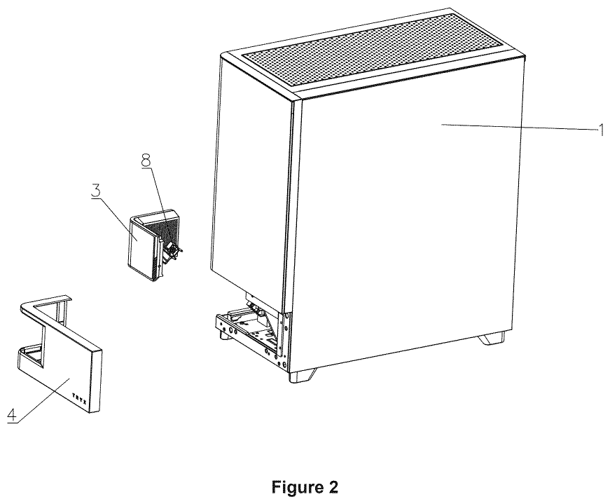

As shown in FIG. 1 to FIG. 2, the case shell 1 has a notch 2. The curved display module 3 is mounted in the notch 2. The notch 2 comprises a first area and a second area. The first area and the second area are non-coplanar. The first display portion 9 is mounted in the first area, and the second display portion 10 is mounted in the second area.

Specifically, the computer case has a front panel, a rear panel, a left side panel and a right side panel. In this embodiment, the first area of the notch is located on the front panel, near the bottom of the front panel. The second area of the notch is located on the left side panel, near the bottom of the left side panel. As shown in FIG. 3, the curved display module 3 further comprises a curved portion 11 connecting the first display portion 9 and the second display portion 10. The curved portion 11 is located at the junction of the front panel and the left side panel.

Regarding the curved form of the curved display module 3, in addition to the embodiment of the present invention, it may also include a third display portion. The third display portion is connected to the first display portion via the second display portion. A third area corresponding to the notch is provided, located on the right side panel. That is, the curved display module 3 can also span three panels of the case shell to form a secondary screen with a curved effect.

In this embodiment, as shown in FIG. 1 to FIG. 3, the inner side of the curved display module 3 is connected by a magnetic snap-fit assembly. The magnetic snap-fit assembly comprises a first engaging member 8 and a second engaging member 7.

The first engaging member 8 is located on the inner side of the curved display module 3, and the second engaging member 7 is located on the case shell. The first engaging member 8 comprises a first magnetic portion and engaging pins arranged circumferentially around the first magnetic portion. The second engaging member comprises a second magnetic portion and engaging slots arranged circumferentially around the second magnetic portion. The first magnetic portion matches with the second magnetic portion to generate a magnetic attraction force. The engaging pins match with the engaging slots.

As shown in FIG. 1 and FIG. 2, an outer fixing seat 4 is provided on the outer side of the curved display module 3. The outer contour of the outer fixing seat 4 matches the outer contour of the notch. The outer fixing seat 4 has a display window 5 matching the curved display module 3. The outer fixing seat 4 is used for mounting the curved display module 3 in the notch 2 of the case shell and for displaying the curved display screen of the curved display module 3 through the display window 5.

Based on the installation and connection method of the magnetic snap-fit assembly and the outer fixing seat, the curved display module is stably fixed in the notch of the computer case.

The computer case is configured with a replaceable mounting block. The outer contour of the replaceable mounting block matches the outer contour of the notch. The replaceable mounting block is used to replace the curved display module for mounting in the notch. After the curved display module is removed, the replaceable mounting block can be installed in the notch to form a complete computer case.

The computer case with a curved surface display of the present invention is provided with a detachable curved display module on the case shell, which can be cancelled and replaced. It can achieve a naked-eye 3D special effect on the computer case, and is very suitable for providing users with functions such as viewing other display pictures or message prompts while using the computer for activities such as gaming.

The above description pertains to specific embodiments of the invention and does not limit the scope of protection thereof. Any modifications or variations made based on the technical concept of this invention shall fall within the scope of protection of this invention.

1. A computer case with a curved surface display, characterized in that the computer case comprising a case shell, a detachable curved display module is mounted on an outer surface of the case shell, the curved display module comprising a first display portion and a second display portion connected to the first display portion, and the first display portion and the second display portion are non-coplanar to form a curved display effect.

2. The computer case with a curved surface display according to claim 1, characterized in that the case shell having a notch, the curved display module is mounted in the notch, the notch comprises a first area and a second area, the first area and the second area are non-coplanar, the first display portion is mounted in the first area, and the second display portion is mounted in the second area.

3. The computer case with a curved surface display according to claim 2, characterized in that the case shell having a front panel, a rear panel, a left side panel and a right side panel, the first area of the notch is located on the front panel, the second area of the notch is located on the left side panel and/or the right side panel, the curved display module comprises a curved portion connecting the first display portion and the second display portion, and the curved portion is located at a junction of the front panel and the left side panel and/or located at a junction of the front panel and the right side panel.

4. The computer case with a curved surface display according to claim 1, characterized in that an inner side of the curved display module is connected by a magnetic snap-fit assembly.

5. The computer case with a curved surface display according to claim 4, characterized in that the magnetic snap-fit assembly comprising a first engaging member and a second engaging member, the first engaging member comprising a first magnetic portion and engaging pins arranged circumferentially around the first magnetic portion, the second engaging member comprising a second magnetic portion and engaging slots arranged circumferentially around the second magnetic portion, the first magnetic portion matches with the second magnetic portion to generate a magnetic attraction force, and the engaging pins match with the engaging slots.

6. The computer case with a curved surface display according to claim 1, characterized in that an outer fixing seat is provided on an outer side of the curved display module, the outer fixing seat has a display window matching the curved display module, the outer fixing seat is used for mounting the curved display module on the case shell, and the curved display screen of the curved display module is displayed through the display window.

7. The computer case with a curved surface display according to claim 1, characterized in that the case shell is configured with a replaceable mounting block, an outer contour of the replaceable mounting block matches an outer contour of the notch, and the replaceable mounting block is used to replace the curved display module for mounted in the notch.

8. The computer case with a curved surface display according to claim 1, characterized in that the curved display module is electrically connected to a mainboard inside the computer case.
